(19) United States
(12) Patent Application Publication
(10) Pub. No.: US 2013/0308075 A1
(43) Pub. Date: Nov. 21, 2013

(54) LIQUID CRYSTAL MODULE AND ELECTRONIC APPARATUS

(71) Applicant: Hisashi Watanabe, Osaka-shi (JP)

(72) Inventor: Hisashi Watanabe, Osaka-shi (JP)

(73) Assignee: SHARP KABUSHIKI KAISHA, Osaka-shi, Osaka (JP)

(21) Appl. No.: 13/825,986

(22) PCT Filed: Sep. 20, 2011
(86) PCT No.: PCT/JP11/05291

§ 371 Date: Mar. 26, 2013

(30) Foreign Application Priority Data
Sep. 27, 2010 (JP) 2010-215734

(51) Int. Cl. G02F 1/1339; G02F 1/1335

(52) U.S. Cl. CPC G02F 1/1339; G02F 1/133602
USPC 349/61; 349/153

(57) ABSTRACT

A resin layer 3 is provided on the outer side of a sealing material 23 so as to cover the sealing material 23, and sealing strength of the sealing material 23 is increased by supporting the sealing material 23 from the outer side using the resin layer 3, by integrally bonding the resin layer 3 and the sealing material 23.

### TECHNICAL FIELD

The present invention relates to a liquid crystal module, and an electronic apparatus which includes the liquid crystal module.

### BACKGROUND ART

The liquid crystal module has been widely used as a display of a television, OA equipment such as a personal computer, a mobile information device such as a mobile phone, or a PDA (Personal Digital Assistant), since the liquid crystal module can be made thin, and of which power consumption is low. The liquid crystal module has a liquid crystal panel which includes an element substrate, an opposing substrate which faces the element substrate, a frame-shaped sealing material which bonds peripheral edge portions of both the element substrate and the opposing substrate to each other in the whole periphery, and a liquid crystal layer into which the sealing material is filled between the element substrate and the opposing substrate. In addition, a display region for displaying an image is formed inside the sealing material of the liquid crystal panel, and a frame region which does not contribute to a display of an image is formed at the outer periphery of the display region.

Meanwhile, in recent years, in a liquid crystal module, a liquid crystal panel in which a display region is enlarged is required in order to obtain an excellent design, and to improve usability in an electronic apparatus. In order to enlarge a display region of a liquid crystal panel, it is necessary to make a frame region narrow, that is, a so-called narrow framing is needed.

As a technology for performing such a narrow framing of a liquid crystal panel, for example, in PTL 1, a technology is disclosed in which a substrate base material is formed by bonding a pair of substrates through a sealing material, and the substrate base material is cut by laser on the sealing material thereof, thereby manufacturing a liquid crystal panel in which the outer end surface of the sealing material and an end surface of each substrate are aligned. In this technology, narrow framing of a liquid crystal panel is executed by removing a useless portion of the substrate on the outer side of the sealing material.

In addition, in the PTL 2, a technology is disclosed in which, in a liquid crystal panel in which a terminal for outside connection which is connected to an external member is formed at a position which goes along one side of a peripheral edge portion of a substrate, the width of a sealing material which goes along the peripheral edge portion of the substrate which is not formed with the terminal for outside connection is set to be narrower than the width of the sealing material on the terminal for outside connection side. In this technology, the narrow framing of a liquid crystal panel is executed by setting the width of the sealing material which goes along the peripheral edge portion of the substrate which is not formed with the terminal for outside connection to be narrow.

### CITATION LIST

### Patent Literature

PTL 1: Japanese Unexamined Patent Application Publication No. 2001-75064 (pages 4 and 7, FIG. 5)

PTL 2: Japanese Unexamined Patent Application Publication No. 2008-151969 (pages 4 and 7, FIG. 1)

### SUMMARY OF INVENTION

### Technical Problem

Meanwhile, in order to make a frame of a liquid crystal panel narrower, making the width of a sealing material narrower is taken into consideration.

However, when the width of a sealing material is too narrow, there is a case in which the sealing material is separated from a substrate in a reliability test of an electronic apparatus which is performed, for example, in circumstances of a high temperature or a high temperature and high humidity, or when the electronic apparatus is used in a region of a high temperature and high humidity, since sealing strength of the sealing material is decreased. In such a case, there has been a problem in that air flows in a liquid crystal layer from the outside of the sealing material, air bubbles are generated in the liquid crystal layer, and the liquid crystal panel becomes defective.

The present invention has been made by taking such a problem into consideration, and an object thereof is to provide a liquid crystal module in which a sealing material is prevented from separating from a substrate even when the width of the sealing material is narrow, and an electronic apparatus which includes the liquid crystal module.

### Solution to Problem

In order to solve the above problem, according to the present invention, a resin layer is provided at the outside of a sealing material so as to cover the sealing material, and the resin layer and the sealing material are integrally bonded.

Specifically, according to a first invention, a liquid crystal module which includes an element substrate; an opposing substrate which faces the element substrate; a frame-shaped sealing material which bonds peripheral edge portions of both the element substrate and opposing substrate in a whole periphery; and a liquid crystal layer which is enclosed in an inner side of the sealing material between the element substrate and the opposing substrate is set as a target.

In addition, a resin layer is provided at least at the outer side of the sealing material of the liquid crystal panel so as to cover the sealing material, and the resin layer and the sealing material are integrally bonded.

According to this configuration, the sealing material is supported by the resin layer from the outside. Since sealing strength of the sealing material is increased due to this, it is possible to prevent the sealing material from separating from the substrate even when the width of the sealing material is narrow.

According to a second invention, in the first invention, the resin layer is formed of a transparent resin, and covers the whole liquid crystal panel.

In this manner, it is possible to easily manufacture the liquid crystal module using insertion molding. Specifically, it is possible to manufacture a liquid crystal module in which the resin layer covers the whole liquid crystal panel by providing a liquid crystal panel in a forming die, and filling resin in the forming die after closing the die.

According to a third invention, in the first invention, a flexible printed circuit board mounting portion is provided at the outer side of the sealing material of the element substrate, and the resin layer is formed of a transparent resin, and covers portions excepting for the flexible printed circuit board mounting portion of the liquid crystal panel.

According to the configuration, it is possible to mount a flexible printed circuit board on the flexible printed circuit board mounting portion after covering the portions excepting for the flexible printed circuit board mounting portion of the liquid crystal panel using the resin layer. Since high heat is generated when mounting the flexible printed circuit board on the flexible printed circuit board mounting portion, and there is a concern that the sealing material may be separated from the substrate due to the heat, by performing processes as described above, it is possible to prevent the sealing material from separating from the substrate since the heat which is transferred to the sealing material is reduced by being absorbed in the resin layer, in addition to the fact that the sealing material is supported by the resin layer from the outer side.

According to a fourth invention, in the second or third invention, a portion corresponding to a peripheral edge portion of the opposing substrate on an outer surface of the resin layer is formed as a convexly curved surface, an inner side portion which is continuous to the convexly curved portion is flatly formed.

According to the configuration, when a user views the convexly curved surface from the opposing substrate side of the resin layer, the user views light which refracts inside the peripheral edge portion (frame region) of the opposing substrate, that is, the display range side, on the convexly curved surface. On the other hand, when the user views the inner side portion which is continuous to the convexly curved surface from the opposing substrate side of the resin layer, that is, the portion on the display range side, the user views light which directly comes from the display region side since the inner portion is flatly formed. Accordingly, it is possible to provide a liquid crystal module in which only the display region is viewed, and a frame region is not viewed, when the user views the outer surface of the resin layer from the opposing substrate side of the resin layer.

According to a fifth invention, in the second or third invention, a front plate which is attached to the outer surface of the opposing substrate, and configures a laminated body along with the liquid crystal panel is further included, and at least one of the front plate and the liquid crystal panel is flexible, and at least one of the front plate and the liquid crystal panel which configure the laminated body is formed as a curved surface using bending deformation, and the resin layer covers the laminated body.

According to the configuration, there is a concern that the front plate and the liquid crystal panel may be separated from each other due to a reaction force against the bending deformation, since the laminated body is configured in a state in which at least one of the front plate and the liquid crystal panel is deformed to be bent, therefore, it is possible to prevent the separation of the front plate and the liquid crystal panel, since the front plate and the liquid crystal panel are pressed by each other by the resin layer, and resist against the reaction force by covering the laminated body with the resin layer.

According to a sixth invention, in any one of the second to fifth inventions, a backlight is further included which is attached to an outer surface of the resin layer on an element substrate side, and illuminates the liquid crystal panel from the element substrate side.

According to the configuration, the backlight is attached to the resin layer after covering the liquid crystal panel with the resin layer. In this manner, it is possible to prevent the backlight from being defective by being contaminated by resin which is infiltrated in the backlight when forming the resin layer. In addition, since the resin layer is formed of transparent resin, the liquid crystal panel can be illuminated by the backlight even when the backlight is attached to the outer surface of the resin layer.

According to a seventh invention, in the sixth invention, an optical film is attached to each of the element substrate side on the resin layer and the outer surface on the opposing substrate side.

The optical film is generally attached to the element substrate and the opposing substrate. In the configuration, when a problem, for example, contamination of a foreign substance between the optical film and each substrate, the optical film itself is defective, or the like, is found after covering the liquid crystal panel with the resin layer, it is not possible to reattaching the optical film by separating the film from both substrates, since the optical film is located inside the resin layer.

In contrast to this, in a configuration in which the optical film is attached to the outer surface of the resin layer as described above, even when the above described problem is found after covering the liquid crystal panel with the resin layer, it is possible to attach the optical film again by separating the optical film from the resin layer, that is, it is possible to perform so-called reworking, since the optical film is attached to the outer surface of the resin layer. For this reason, it is possible to reduce the manufacturing cost of the liquid crystal module.

According to an eighth invention, in the second or third invention, the resin layer further includes the backlight which is formed in a flat-plate shape, is attached to the outer surface of the resin layer on the element substrate side, and illuminates the liquid crystal panel from the element substrate side, and at least one of an outer side surface and an inner side surface of the resin layer is set to have lower reflectivity than that of other surfaces of the resin layer.

According to the configuration, since the backlight is attached to the outer surface of the resin layer on the element substrate side, light which is output from the backlight is reflected on the outer side surface or inner side surface of the resin layer, accordingly, there is a case in which the reflected light leaks, and comes out to the opposing substrate side of the resin layer. In such a case, since the periphery of the display region becomes bright due to the light which leaks and comes out, and there is a concern that the brightness may give a sense of unease to a user, it is possible to reduce the light which leaks, and comes out to the opposing substrate side of the resin layer by setting reflectivity of at least one of the outer side surface and inner side surface of the resin layer to be low. Accordingly, a user can be prevented from being given a sense of unease, since it is possible to prevent the periphery of the display region from being bright.

According to a ninth invention, in the second or third invention, the resin layer further includes the backlight which is formed in the flat-plate shape, is attached to the outer surface of the resin layer on the element substrate side, and illuminates the liquid crystal panel from the element substrate side, and in which at least one of a portion corresponding to a peripheral edge portion of the element substrate on the outer surface of the resin layer, and a portion corresponding to a peripheral edge portion of the opposing substrate is set to have lower transmittance of light than that in other portions of the resin layer.

According to the configuration, there is a concern that light which is output from the backlight leaks, and comes out to the opposing substrate side of the resin layer, and as a result, the periphery of the display region may become bright due to the leaked light, and it may give a sense of unease to a user, since the backlight is attached to the outer surface of the resin layer on the element substrate side, it is possible to reduce the light which leaks, and comes out to the opposing substrate side of the resin layer by shielding a part of, or the whole light which comes to the opposing substrate side of the resin layer, by setting the transmittance of light of at least one of the portion corresponding to the peripheral edge portion of the element substrate on the outer side surface of the resin layer and the portion corresponding to the peripheral edge portion of the opposing substrate to be low. Accordingly, a user is not given a sense of unease since the periphery of the display region is prevented from being bright.

According to a tenth invention, in the second or third invention, the resin layer further includes the backlight which is formed in the flat-plate shape, is attached to the outer surface of the resin layer on the element substrate side, and illuminates the liquid crystal panel from the element substrate side, and the outer side surface of the resin layer is formed as a light scattering surface.

According to the configuration, since the backlight is attached to the outer surface of the resin layer on the element substrate side, light which is output from the backlight is reflected on the outer side surface of the resin layer, and there is a case in which the reflected light leaks, and comes out to the opposing substrate side of the resin layer. In this case, since there is a concern that the periphery of the display region becomes bright due to the leaked light, and may give a sense of unease to a user, by forming the light scattering surface on the outer side surface of the resin layer, it is possible to reduce the light which leaks, and comes out to the opposing substrate side of the resin layer, since light which reaches the outer side surface of the resin layer from the backlight is scattered. Accordingly, a user is not given a sense of unease since the periphery of the display region is prevented from being bright.

An eleventh invention relates to an electronic apparatus. In addition, the invention includes the liquid crystal module according to any one of the first to tenth inventions.

In this manner, when a reliable test of an electronic apparatus which is performed in circumstances of a high temperature or a high temperature and high humidity, or when the electronic apparatus is used in a region of a high temperature and high humidity, it is possible to prevent the liquid crystal panel from being defective due to the separating of the sealing material from the substrate, even when the width of the sealing material is narrow.

### Advantageous Effects of Invention

As described above, in the present invention, it is possible to increase sealing strength of a sealing material since a resin layer is provided at the outer side of the sealing material so as to cover the sealing material since the resin layer and the sealing material are integrally bonded. Accordingly, even when the width of the sealing material is narrow, it is possible to prevent the sealing material from separating from a substrate.

### BRIEF DESCRIPTION OF DRAWINGS

FIG. 1 is a schematic perspective view of a liquid crystal module according to a first embodiment.

FIG. 2 is a schematic plan view of the liquid crystal module according to the first embodiment.

FIG. 3 is a cross-sectional view which is taken along line III-III in FIG. 2.

FIG. 4 is a cross-sectional view which is taken along line IV-IV in FIG. 2.

FIG. 5 is an enlarged view of a main portion of the liquid crystal module according to the first embodiment.

FIG. 6 is a diagram which describes a manufacturing method of the liquid crystal module according to the first embodiment.

FIG. 7 is a diagram corresponding to FIG. 6(a), which illustrates a modification example of a lower die.

FIG. 8 is a perspective view of the lower die according to the modification example.

FIG. 9 is a diagram corresponding to FIG. 5, which illustrates a liquid crystal module according to a modification example 1 in which the outer side surface of a resin layer is formed as a light scattering surface.

FIG. 10 is a diagram of a liquid crystal module according to a modification example 2, which corresponds to FIG. 5.

FIG. 11 is a diagram of a liquid crystal module according to a modification example 3, which corresponds to FIG. 2.

FIG. 12 is a cross-sectional view which is taken along line XII-XII in FIG. 11.

FIG. 13 is a diagram of a liquid crystal module according to a modification example 4, which corresponds to FIG. 3.

FIG. 14 is a diagram of a liquid crystal module according to a modification example 4, which corresponds to FIG. 4.

FIG. 15 is a diagram of a liquid crystal module including a front plate, which corresponds to FIG. 5.

FIG. 16 is a diagram which illustrates a modification example of a liquid crystal module including the front plate, which corresponds to FIG. 5.

FIG. 17 is a diagram which illustrates a further another modification example of a liquid crystal module including the front plate, which corresponds to FIG. 5.

FIG. 18 is a diagram of a liquid crystal module according to a second embodiment, which corresponds to FIG. 3.

FIG. 19 is a diagram which describes a manufacturing method of a liquid crystal module according to the second embodiment.

FIG. 20 is a schematic front view of a mobile phone according to a third embodiment.

FIG. 21 is a cross-sectional view which is taken along line XXI-XXI in FIG. 20.

FIG. 22 is a cross-sectional view which is taken along line XXII-XXII in FIG. 20.

### DESCRIPTION OF EMBODIMENTS

Hereinafter, embodiments of the present invention will be described in detail with reference to drawings. In addition, descriptions of preferable embodiments below are merely examples, intrinsically.

### First Embodiment

### Configuration of Liquid Crystal Module

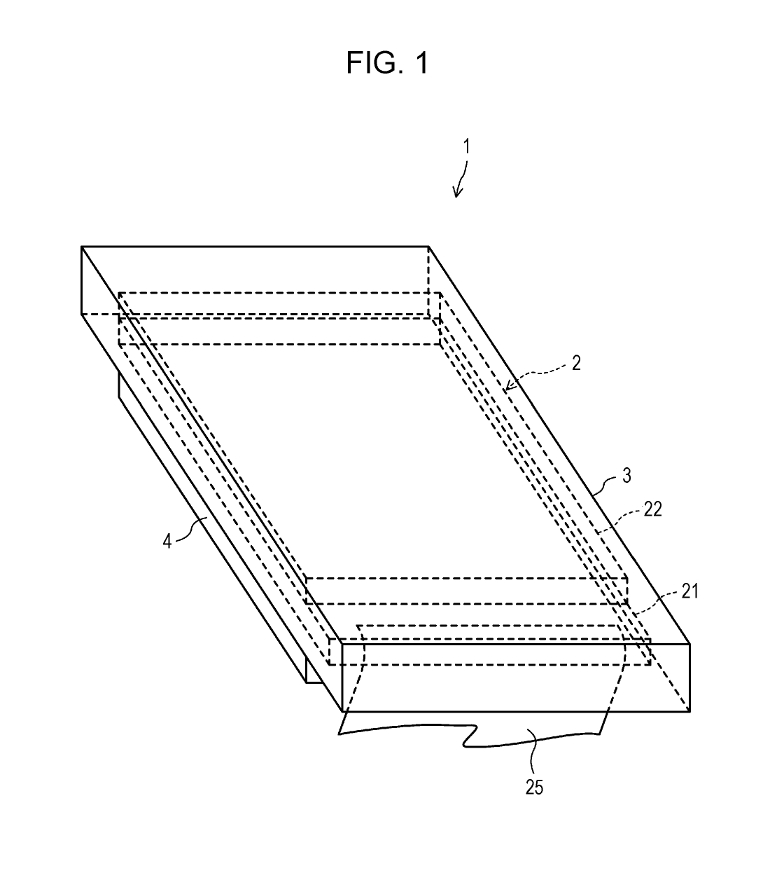

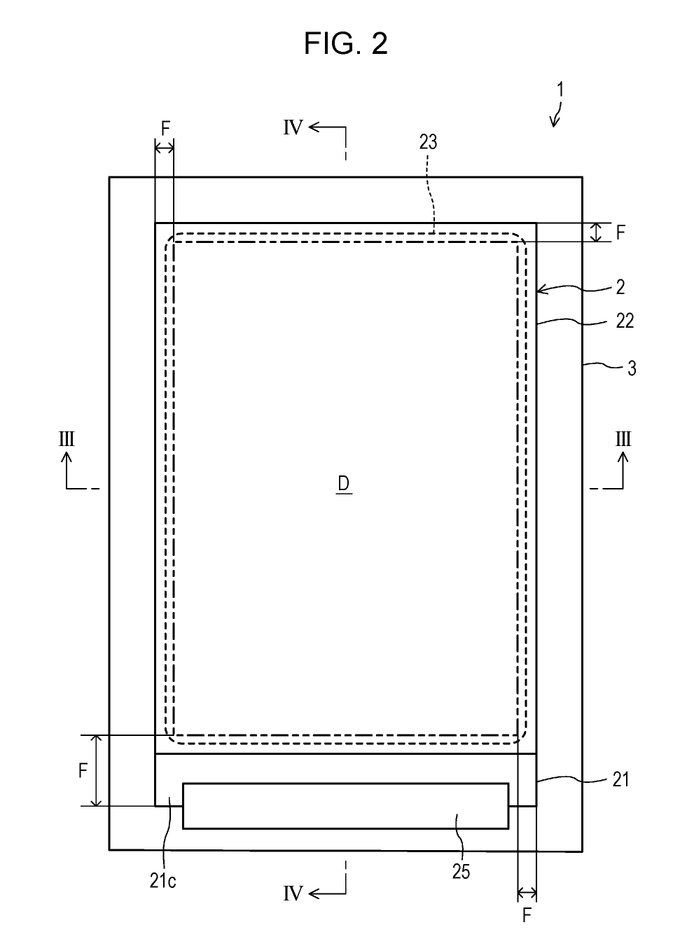

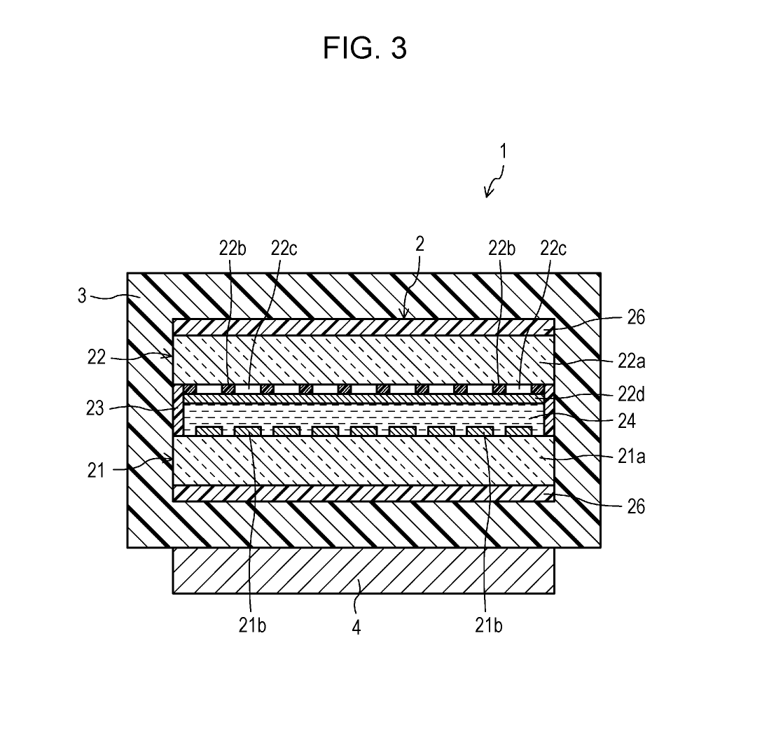

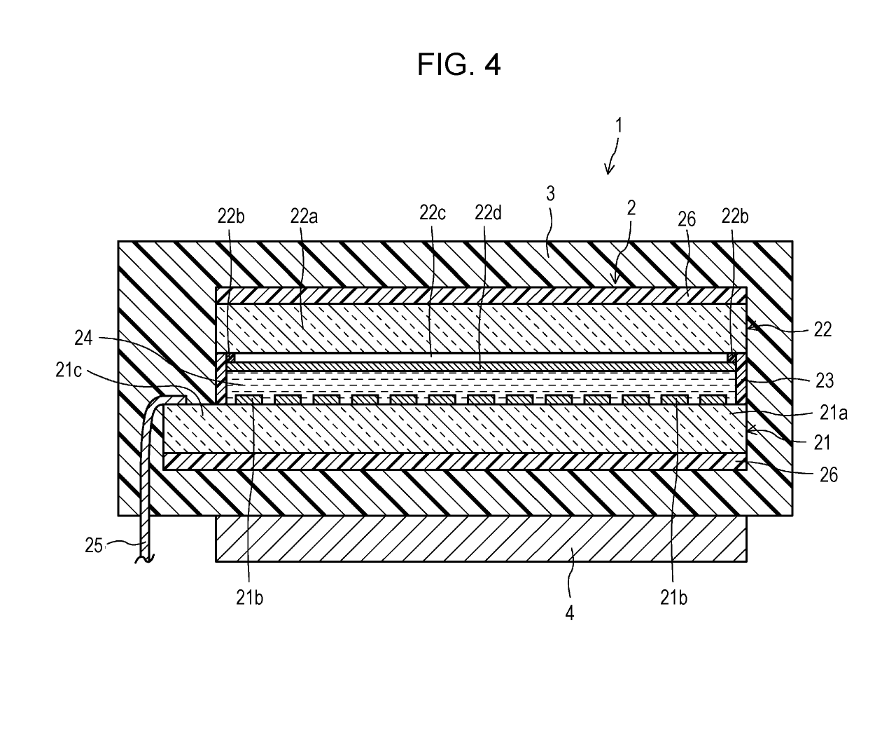

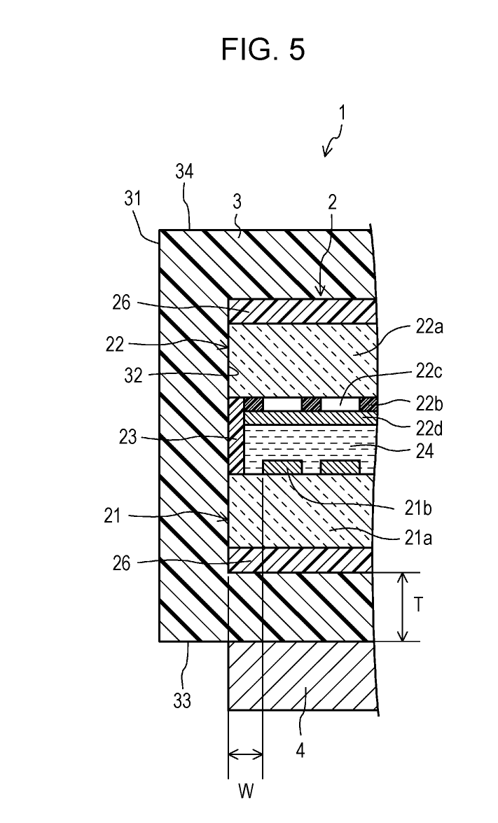

FIG. 1 is a schematic perspective view of a liquid crystal module 1 according to a first embodiment of the present invention. FIG. 2 is a schematic plan view of the liquid crystal module 1, FIG. 3 is a cross-sectional view which is taken along line III-III in FIG. 2, FIG. 4 is a cross-sectional view which is taken along line IV-IV in FIG. 2, and FIG. 5 illustrates an enlarged view of a main portion of the liquid crystal module 1, respectively. In addition, in FIG. 2, a configuration of the liquid crystal module 1 which is viewed through a resin layer 3 is denoted by a solid line.

The liquid crystal module 1 is an active matrix driving type liquid crystal module which is used as a display of a television, OA equipment such as a personal computer, a mobile information device such as a mobile phone, a PDA (Personal Digital Assistant), or the like. The liquid crystal module 1 includes a liquid crystal panel 2 and a backlight 4 which illuminates the liquid crystal panel 2.

The liquid crystal panel 2 includes a thin film transistor substrate 21 (hereinafter, referred to as TFT substrate) as an element substrate, a color filter substrate 22 (hereinafter, referred to as CF substrate) as an opposing substrate which faces the TFT substrate 21, a frame shaped sealing material 23 which bonds peripheral edge portions of both the TFT substrate 21 and the CF substrate 22 in the whole periphery, and a liquid crystal layer 24 which is enclosed in the sealing material 23 between the TFT substrate 21 and the CF substrate 22.

As illustrated in FIG. 2, a display region D for displaying an image is formed inside the sealing material 23 of the liquid crystal panel 2, that is, a region at which the liquid crystal layer 24 is provided, and in the outer periphery of the display region D, a frame region F which does not contribute to a display of an image is formed.

The display region D is a rectangular region, and is configured by a plurality of pixels as a minimum unit of an image which are arranged in a matrix.

The TFT substrate 21 has a configuration which is generally used in the related art, and for example, is configured by including a plurality of display wires (not shown) which are formed by gate wires and source wires which are provided in a lattice pattern on an insulating substrate (glass substrate) 21a of a rectangular flat-plate shape, for example, so as to distinguish each pixel, a thin film transistor (hereinafter, briefly referred to as TFT) which is provide in each pixel (not shown), and a pixel electrode 21b which is in a conduction state with each TFT.

In addition, one side of the TFT substrate 21 protrudes from the CF substrate 22, and a protrusion portion thereof, that is, the outer side of the sealing material 23 of the TFT substrate 21 becomes a flexible printed circuit mounting portion 21c (hereinafter, referred to as FPC mounting portion).

The FPC mounting portion 21c is mounted with, for example, a driver LSI (not shown) which drives the plurality of TFTs, or an FPC 25 which is connected to an external circuit board.

In the FPC 25, a plurality of wires are formed densely, and a necessary control signal is supplied to the driver LSI from the external circuit board through the plurality of wires.

In addition, here, the TFT substrate 21 has a structure of a so-called COG (Chip On Glass) in which the driver LSI is mounted on an insulating substrate 21a, however, it may be a TFT substrate of a so-called COF (Chip On Film) structure in which the driver LSI is mounted on the FPC 25.

The CF substrate 22 also has a configuration which has been generally used in the related art, and for example, it is configured by including black matrices 22b which are provided in a stripe shape and a frame shape on the surface on the liquid crystal layer 24 side of the insulating substrate (glass substrate) 22a of a rectangular flat-plate shape, and color filters 22c of a plurality of colors which are provided in a stripe shape so as to be periodically arranged between neighboring black matrices 22b, and including a red layer (R), a green layer (G), and a blue layer (B). In addition, a common electrode 22d is provided so as to cover the black matrices 22b and the color filters 22c, and a pillar shaped photo spacer (not shown) is provided on the common electrode 22d.

These TFT substrate 21 and the CF substrate 22 are provided with an orientation film (not shown) on the surface on the liquid crystal layer 24 side, respectively, and meanwhile, one or a plurality of optical films 26 are respectively attached to the surface on the opposite side to the liquid crystal layer 24. The optical film 26 is formed only by a polarizing plate, or by the polarizing plate and other optical films than that (for example, phase difference film).

The sealing material 23 is, for example, a material in which raw materials of the sealing material which is formed of a thermosetting resin, an ultraviolet curable resin, or the like is cured. In addition, the sealing material 23 is provided between the TFT substrate 21 and the CF substrate 22 so that the outer end surface thereof, the end surface of the CF substrate 22, and the end surface of the TFT substrate 21 excepting for the FPC mounting portion 21c are arranged to be flush. In addition, as illustrated in FIG. 5, a distance W between the outer end surface of the sealing material 23 and the pixel electrode 21b which is closest thereto, that is, the width of the frame region F is set to approximately 0.5 mm.

A resin layer 3 which will be described in detail later is provided at the outer side of the sealing material 23 so as to cover the sealing material 23, and the resin layer 3 and the sealing material 23 are integrally bonded.

The liquid crystal layer 24 is configured of a nematic liquid crystal material having an electro-optical property.

The liquid crystal panel 2 is configured as described above. The whole liquid crystal panel 2 is covered with the resin layer 3, and is integrally bonded to the resin layer 3. In this manner, as described above, the sealing material 23 is covered with the resin layer 3 from the outer side, and is integrally bonded to the resin layer 3.

The resin layer 3 is formed, for example, of a transparent resin such as an acrylic resin (thermoplastic resin). In addition, a resin material of the resin layer 3 is not limited to the thermoplastic resin, and it may be a thermosetting resin if it is a transparent resin. In addition, the resin material of the resin layer 3 may be a UV curable resin, and it may be one component resin, or two component resin. In addition, the resin layer 3 is formed in a rectangular flat-plate shape corresponding to the liquid crystal panel 2 (TFT substrate 21 and CF substrate 22). In addition, here, the thickness T of the resin layer 3 which is illustrated in FIG. 5 is set to approximately 1 mm. The thickness T of the resin layer 3 is appropriately set in consideration of easiness of injecting a resin material into a cavity 53 of a molding die 5 when manufacturing the liquid crystal module 1 which will be described later, strength of the liquid crystal module 1, and reducing of light which leaks and comes out to the CF substrate 22 side of the resin layer 3 which will be described in a modification example 1 according to a first embodiment which will be described later.

The backlight 4 is attached to the outer surface of the resin layer 3 on the TFT substrate 21 side. Here, since the resin layer 3 is formed of a transparent resin, even when the backlight 4 is attached to the outer surface of the resin layer 3, the backlight 4 is able to illuminate the liquid crystal panel 2. In addition, from the outer surface of the resin layer 3 on the TFT substrate 21 side, a part of the FPC 25 is exposed to the outside of the resin layer 3. In this manner, it is possible to connect the FPC 25 to the external circuit board.

The backlight 4 is of a so-called edge lighting method. Specifically, the backlight 4 has a structure in which a light source (for example, cold cathode fluorescent tube, or light emitting diode) (not shown) is provided at one side of a light guiding plate (not shown), a plurality of optical sheets (for example, prism sheet, or diffusing plate) (not shown) are provided on the surface of the light guiding plate on the liquid crystal panel 2 side, and a reflective sheet (not shown) is provided on the surface of the light guiding plate on the opposite side to the liquid crystal panel 2. In addition, the backlight 4 may be a direct lighting backlight, in addition to the edge lighting method which is described here.

The liquid crystal module 1 is configured as described above, and in the liquid crystal module 1 having this configuration, the TFT is set to ON state through the display wiring in each pixel, a potential difference occurs between the pixel electrode 21b and the common electrode 22d by writing a predetermined charge in the pixel electrode 21b through the TFT, and as a result, a predetermined voltage is applied to the liquid crystal layer 24. In addition, in the liquid crystal module 1, an orientation state of liquid crystal molecules is caused to be changed by a magnitude of the voltage which is applied to the liquid crystal layer 24, and it is possible to display a desired image by adjusting transmittance of light of the liquid crystal layer 24 by doing that.

### Manufacturing Method of Liquid Crystal Module

Subsequently, a manufacturing method of the liquid crystal module 1 will be described.

The manufacturing method of liquid crystal module 1 includes a liquid crystal panel manufacturing process and a resin layer forming process.

### Liquid Crystal Panel Manufacturing Process

The manufacturing method of a liquid crystal panel 2 has been known in the related art, and an example thereof will be simply described here.

First, a mother board for obtaining a plurality of TFT substrates 21 and CF substrates 22 is manufactured. Specifically, a first mother board for obtaining the plurality of TFT substrates 21, and a second mother board for obtaining the plurality of CF substrates 22 are manufactured. A method of manufacturing the first mother board is that an insulating board is prepared, a deposition process such as a sputtering method, or CVD (Chemical Vapor Deposition), or the like, and a patterning process such as photolithography, or the like are repeatedly performed on the insulating board, and the display wiring, the TFT, and the pixel electrode 21b are formed. A method of manufacturing the second mother board is that an insulating board is prepared, an applying process of a photosensitive resin using a spin coating method, a slit coating method, or the like, and an exposing process, and a patterning process using developing of the photosensitive resin are repeatedly performed on the insulating film, thereby forming the black matrix 22b and the color filter 22c. Subsequently, after forming the common electrode 22d using the sputtering method, the photo spacer is formed by performing the applying process of the photosensitive resin using the spin coating method, and by performing the exposing, and the patterning process using the developing of the photosensitive resin.

Subsequently, a solution in which a polyimide resin is input to a solvent is applied onto the surface of the first mother board and the second mother board according to a printing method, and ingredients of the solvent of the applied solution are vaporized by being baked, thereby forming orientation films on the surfaces of both mother boards. Subsequently, rubbing processing is performed with respect to the orientation films of both the mother boards.

Subsequently, when a bonded mother board which will be described later is divided into an individual liquid crystal panel 2 a raw material of the sealing material is applied so as to surround the periphery of portions which are the display region D in a frame shape using a dispenser, or a screen printing method with respect to the first mother board. In addition, in the region which is surrounded by the raw material of the sealing material, a liquid crystal material of a predetermined amount is dropped using the dispenser.

Subsequently, the first mother board and the second mother board are bonded, and the bonded mother board is obtained. In addition, UV irradiation and/or heating is performed with respect to the raw material of the sealing material of the bonded mother board, the raw material of the sealing material is cured, thereby forming the sealing material 23.

Subsequently, the plurality of liquid crystal panels 2 in which the outer end surface of the sealing material 23, the end surface of the CF substrate 22, and the end surface of the TFT substrate 21 excluding the FPC mounting portion 21c are arranged to be flush are manufactured by cutting a bonded mother board by a dicing method using a rotating blade, or a laser by using the upper part of the sealing material 23 as a cutting line.

Finally, the optical films 26 are attached to the respective surfaces on the opposite side to TFT substrate 21 of the liquid crystal panel 2 and liquid crystal layer 24 of the CF substrate 22.

The driver LSI and the FPC 25 are mounted on the FPC mounting portion 21c of the liquid crystal panel 2 which is manufactured in this manner, using heat pressing through, for example, an anisotropic conductive film.

### Resin Layer Forming Processing

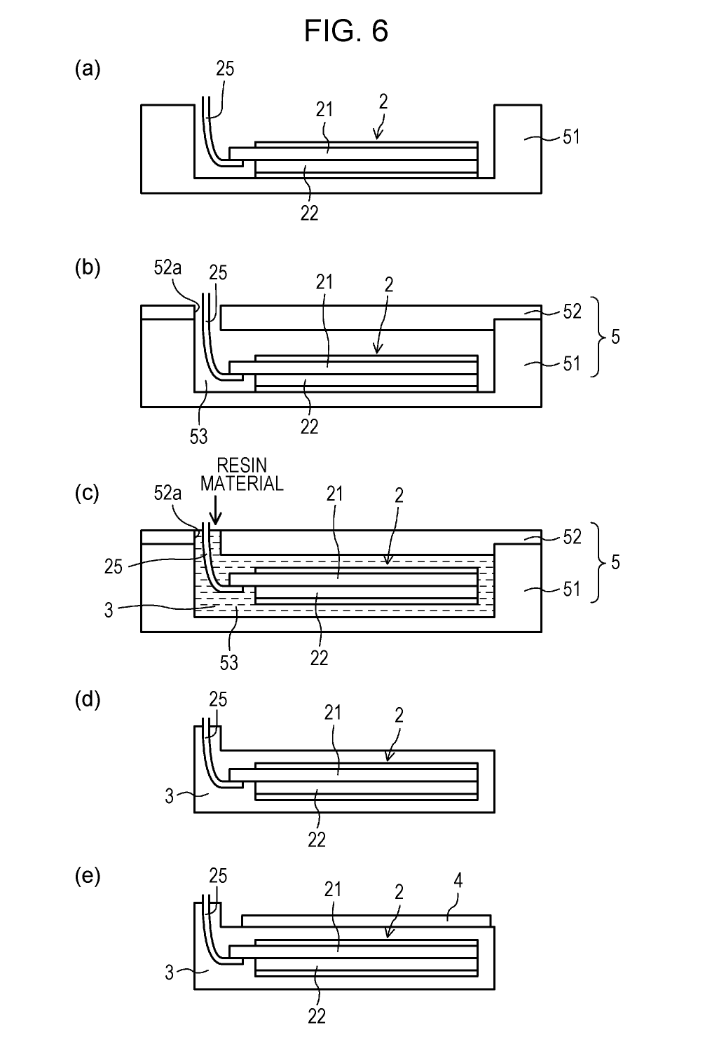

In the resin layer forming processing, insertion molding is performed so as to provide the resin layer 3 in the liquid crystal panel 2 which is manufactured in the liquid crystal panel manufacturing processing. As illustrated in FIG. 6, a forming die 5 for performing the insertion molding is formed of a lower die 51 of which the base is made planar, and an upper die 52, and the upper die 52 is provided with an injection hole 52a for injecting a resin material (for example, acrylic resin in liquefaction state) of the resin layer 3. Hereinafter, a method of providing the resin layer 3 in the liquid crystal panel 2 using the forming die 5 will be described in detail with reference to FIG. 6.

First, as illustrated in FIG. 6(a), the liquid crystal panel 2 is provided at the base of the lower die 51 so that the TFT substrate 21 side becomes the upper side. At this time, the liquid crystal panel 2 is positioned so that a part of the FPC 25 is exposed to the outside of the forming die 5 from the injection hole 52a of the upper die 52, in a state in which the forming die 5 is closed.

Subsequently, as illustrated in FIG. 6(b), the die is closed by placing the upper die 52 on the lower die 51. In this manner, a cavity 53 is formed in the forming die 5, and the liquid crystal panel 2 is provided in the cavity 53, and the part of the FPC 25 is exposed to the outside of the forming die 5 from the injection hole 52a.

Subsequently, as illustrated in FIG. 6(c), the resin material of the resin layer 3 is injected into the cavity 53 from the injection hole 52a, and the resin material is filled in the cavity 53. In this manner, the resin material wraps the liquid crystal panel 2 around, and the whole liquid crystal panel 2 is covered with the resin material.

In addition, when being taken out from the forming die 5 after performing cooling hardening of the resin material, the entire body is covered with the resin layer 3 as illustrated in FIG. 6(d), and it is possible to obtain the liquid crystal panel 2 which is integrally bonded to the resin layer 3.

Finally, as illustrated in FIG. 6(e), the liquid crystal module 1 can be manufacture by attaching the backlight 4 to the outer surface of the TFT substrate 21 side of the resin layer 3, and by cutting (finishing) an unnecessary portion corresponding to the injection hole 52a of the resin layer 3.

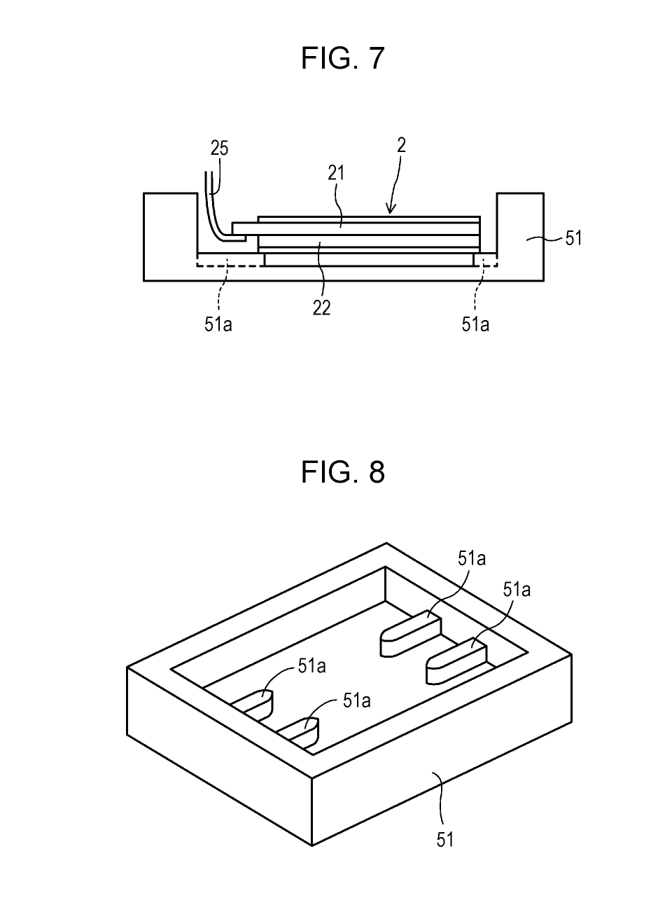

In addition, as illustrated in FIGS. 7 and 8, it may be a configuration in which two sets of a set of protrusions 51a and 51a which are facing each other are provided in line at the base of the lower die 51, and the liquid crystal panel 2 is placed on these four protrusions 51a, 51a, . . . . In this manner, it is possible to stably support the liquid crystal panel 2 using four protrusions 51a, 51a, . . . , and to cause the resin material to reliably wrap around the liquid crystal panel 2. However, in order to make the resin layer 3 not be formed at a portion corresponding to each protrusion 51a, that is, at a part on the CF substrate 22 side, it is necessary to design each protrusion 61a so that the portion is not located at the display region D, in other words, so as to locate at the frame region F, and to place the liquid crystal panel 2 on each of the protrusions 61a by positioning thereof.

### Effect of First Embodiment

According to the first embodiment, the sealing material 23 is supported by the resin material 3 from the outer side by providing the resin layer 3 at the outer side of the sealing material 23 of the liquid crystal panel 2 so as to cover the sealing material 23, and integrally bonding the resin material 3 and the sealing material 23. In this manner, since the sealing strength of the sealing material 23 is increased, it is possible to prevent the sealing material 23 from separating from the TFT substrate 21, or the CF substrate 22 even when the width of the sealing material 23 is narrow. In addition, when inventors of the present application cause the liquid crystal panel 2 and the liquid crystal module 1 to be accommodated in a thermostatic bath which is set to a temperature of 70° C., and in a thermostatic and humidifying bath which is set to a temperature of 60° C., and a humidity of 90%, respectively, for 1000 hours in order to confirm the result, the sealing material 23 of the liquid crystal panel 2 which is not covered with the resin layer 3 was separated from the TFT substrate 21, or the CF substrate 22, however, the sealing material 23 of the liquid crystal module 1 in which the liquid crystal panel 2 is covered with the resin layer 3 was not separated from the TFT substrate 21, or the CF substrate 22. In addition, even if the sealing material 23 is separated from the TFT substrate 21, or the CF substrate 22, since the liquid crystal panel 2 is closed by the resin layer 3, there is no case in which the liquid crystal layer 24 is exposed to the ambient air, and air bubbles are generated in the liquid crystal layer 24.

In addition, since the liquid crystal module 1 has a simple structure in which the whole liquid crystal panel 2 is covered with the resin layer 3, it is possible to easily manufacture the liquid crystal module using the insertion molding.

Further, since the backlight 4 is attached to the outer surface of the resin layer 3 after covering the liquid crystal panel 2 with the resin layer 3, when forming the resin layer 3, it is possible to avoid a situation in which the optical member of the backlight 4 (for example, prism sheet, light guiding plate, or the like) is contaminated, and becomes defective due to infiltrating of the resin material in the backlight 4.

In addition, since the optical film 26 is provided between the resin layer 3, and the TFT substrate 21 and CF substrate 22, even when forming the resin layer 3 using a resin material with relatively high birefringence, for example, or even when air bubbles, or dirt is mixed in the resin layer 3, there is no problem in image displaying of the liquid crystal module 1, differently from the modification example 2 which will be described later.

The first embodiment may be the following modification example.

### Modification Example 1 of First Embodiment

In a liquid crystal module according to a modification example 1, reflectivity on the outer side surface 31 and the inner side surface 32 of a resin layer 3 which is illustrated in FIG. 5 is set to be lower than that on other surfaces of the resin layer 3. In order to set the reflectivity on the outer side surface 31 and the inner side surface 32 of the resin layer 3 to be low, the end surfaces of the outer side surface 31 of the resin layer 3 and the end surface of the liquid crystal panel 2, more specifically, the end surface of the TFT substrate 21, the end surface of the CF substrate 22, and the outer end surface of the sealing material 23 may be printed with black ink, or a black tape may be attached thereto.

According to the first embodiment, since the backlight 4 is attached to the outer surface of the TFT substrate 21 of the resin layer 3, there is a case in which light which is output from the backlight 4 is reflected on the outer side surface 31, or the inner side surface 32 of the resin layer 3, and the reflected light leaks and comes out to the CF substrate 22 side of the resin layer 3. Such a phenomenon easily occurs when a distance between the backlight 4 and the liquid crystal panel 2, that is, the thickness T of the resin layer 3 becomes larger, and the periphery of the display region of the liquid crystal panel 2 becomes bright due to the leaked light, and there is a concern that a user may get a sense of unease because of the brightness.

In contrast to this, in the modification example 1, since the reflectivity on the outer side surface 31 and the inner side surface 32 of the resin layer 3 are set to be low, it is possible to reduce the light which leaks and comes out to the CF substrate 22 side of the resin layer 3. Accordingly, since the periphery of the display region of the liquid crystal panel 2 is prevented from being bright, there is no case of giving a user the sense of unease. In addition, any reflectivity of the outer side surface 31 and the inner side surface 32 of the resin layer 3 may be set to be low, and it is possible to obtain the same effect even in this case.

In addition, transmittance of light of a TFT substrate peripheral edge corresponding portion 33 which corresponds to the peripheral edge portion of the TFT substrate 21 on the outer surface of the resin layer 3, and the CF substrate peripheral edge corresponding portion 34 which corresponds to the peripheral edge portion of the CF substrate 22 may be set to be lower than that in other portions of the resin layer 3. In order to set the transmittance of light of the TFT substrate peripheral edge corresponding portion 33, and the CF substrate peripheral edge corresponding portion 34 to be low, similarly to the above descriptions, the TFT substrate peripheral edge corresponding portion 33, or the CF substrate peripheral edge corresponding portion 34 of the resin layer 3 may be printed with black ink, or may be attached with a black tape.

In this manner, it is possible to reduce the light which leaks and comes out to the CF substrate 22 side of the resin layer 3 by shielding a part, or all of the light which goes toward the CF substrate 22 side of the resin layer 3 on the outer side (that is, frame region) of the display region. Accordingly, since the periphery of the display region of the liquid crystal panel 2 is prevented from being bright, there is no case of giving a user the sense of unease. In addition, any reflectivity of the TFT substrate peripheral edge corresponding portion 33 and the CF substrate peripheral edge corresponding portion 34 may be set to be low, and it is possible to obtain the same effect even in this case. In addition, by attaching another color (not black), for example, a red tape to the TFT substrate peripheral edge corresponding portion 33, or the CF substrate peripheral edge corresponding portion 34, it is possible to add to the beauty of the liquid crystal panel by making the periphery of the display region of the liquid crystal panel 2 glow red, dimly.

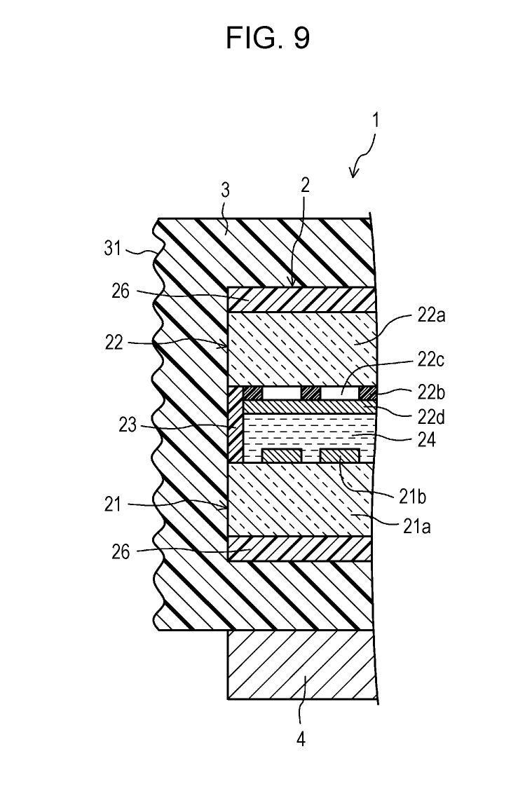

Further, as illustrated in FIG. 9, the outer side surface 31 of the resin layer 3 may be formed as a light scattering surface of an uneven shape.

In this manner, since light which reaches the outer side surface 31 of the resin layer 3 from the backlight 4 is scattered, it is possible to reduce the light which leaks and comes out to the CF substrate 22 side of the resin layer 3. Accordingly, since it is possible to prevent the periphery of the display region of the liquid crystal panel 2 is prevented from being bright, there is no case of giving a user the sense of unease.

### Modification Example 2 of First Embodiment

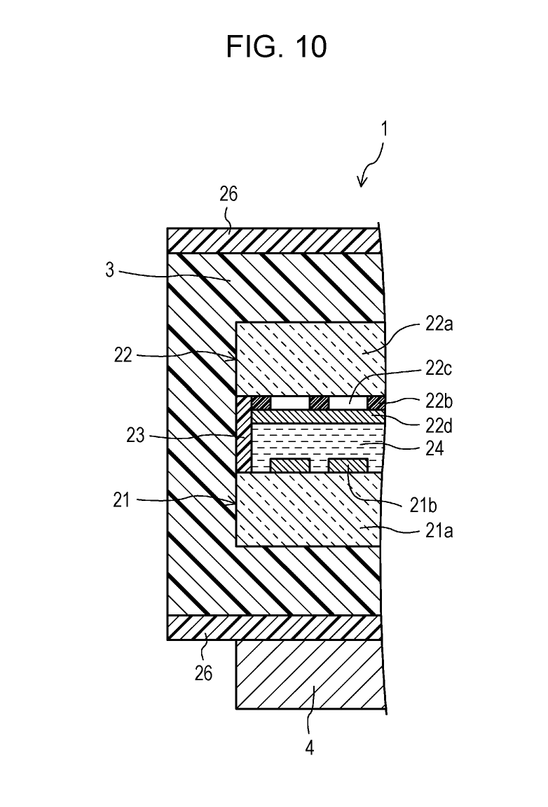

FIG. 10 is a diagram of a liquid crystal module according to a modification example 2 of the first embodiment, and corresponds to FIG. 5. In the modification example 2, only an arrangement of the optical film is different from the first embodiment. Therefore, the optical film will be mainly described. In addition, in FIG. 10, the same configurations as those in the first embodiment will be given the same reference numerals.

In the liquid crystal module according to the modification example 2, an optical film 26 is not attached to the TFT substrate 21 and the CF substrate 22, and is attached to the TFT substrate 21 side of the resin layer 3, and the outer surface on the CF substrate 22 side.

When the optical film 26 is attached to the TFT substrate 21 and the CF substrate 22, since the optical film 26 is located inside the resin layer 3, it is not possible to separate the optical film 26 from both substrates 21 and 22, and reattach the film when founding a problem that, for example, a foreign substance is mixed between the optical film 26 and both the substrates 21 and 22, the optical film 26 itself is defective, or the like, after covering the liquid crystal panel 2 with the resin layer 3.

In contrast to this, by having the above configuration, since the optical film 26 is attached to the outer surface of the resin layer 3, even when the above described problem is found after covering the liquid crystal panel 2 with the resin layer 3, it is possible to perform so-called reworking of separating the optical film 26 from the resin layer 3, and reattaching to the outer surface of the resin layer 3, since the optical film 26 is attached to the outer surface of the resin layer 3. For this reason, it is possible to reduce the manufacturing cost of the liquid crystal module. However, since an image display quality of the liquid crystal module 1 (for example, contrast, coloring, or the like) is deteriorated when the resin layer 3 is formed using a resin material with relatively high birefringence, or when air bubbles, or dust is mixed in the resin layer 3, it is necessary to take a measure of, for example, using a resin with low birefringence (for example, cycloolefin-based resin) as the resin material of the resin layer 3, or the like.

### Modification Example 3 of First Embodiment

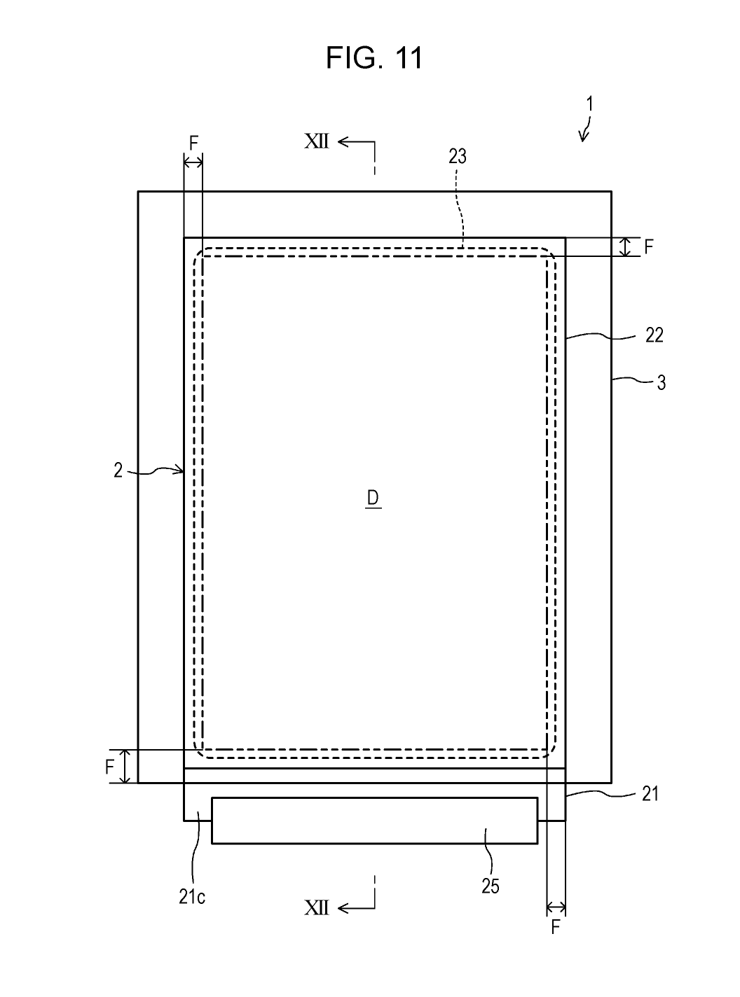

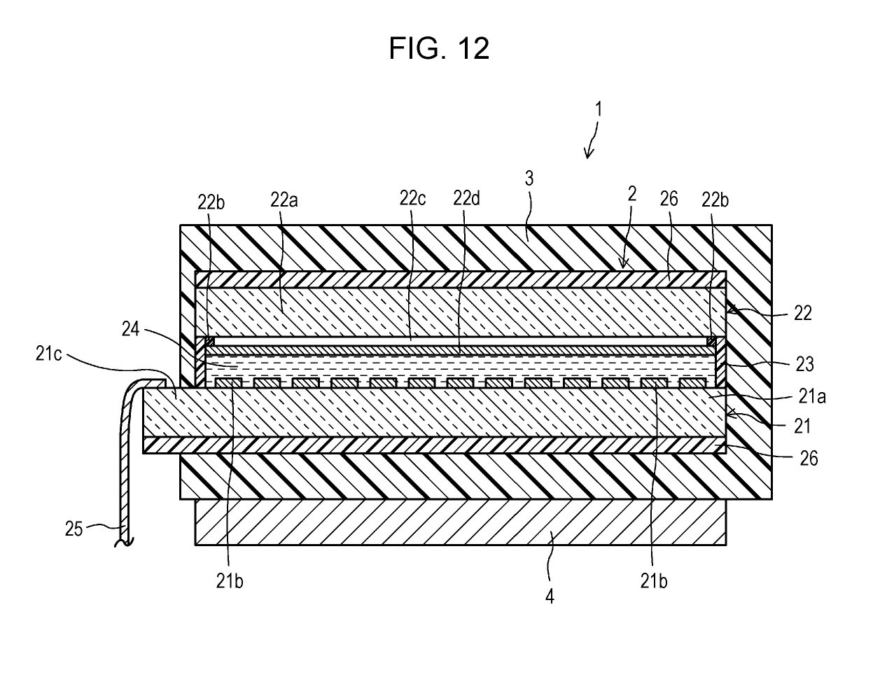

FIG. 11 is a schematic plan view of the liquid crystal module 1 according to a modification example 3 of the first embodiment, and FIG. 12 is a cross-sectional view which is taken along line XII-XII in FIG. 11. In addition, in FIGS. 11 and 12, the same configurations as those in the first embodiment will be given the same reference numerals.

A liquid crystal module 1 according to the modification example 3 is different from the first embodiment in that a portion excepting for an FPC mounting portion 21c of a liquid crystal panel 2 is covered with a resin layer 3, not the whole liquid crystal panel 2.

According to the configuration, it is possible to mount a driver LSI, or an FPC 25 on the FPC mounting portion 21c after covering portions excepting for the FPC mounting portion 21c of the liquid crystal panel 2 with the resin layer 3. As in the first embodiment, when mounting the driver LSI, or the FPC 25 on the FPC mounting portion 21c before covering the liquid crystal panel 2 with resin layer 3, there is a concern that the sealing material 23 is separated from the TFT substrate 21, or the CF substrate 22 due to heat which is generated when performing heat pressing of the driver LSI, or the FPC 25 with respect to the FPC mounting portion 21c, when the width of the sealing material 23 is extremely narrow (for example, 0.05 mm or less), and a sealing strength is extremely low. Therefore, by doing as described above, it is possible to prevent the sealing material 23 from separating from the TFT substrate 21, or the CF substrate 22 since the sealing material is supported by the resin layer 3 from the outer side, and heat which is transferred to the sealing material 23 is reduced by being absorbed to the resin layer 3. In addition, it is also effective when it is required that a process of mounting the FPC 25 on the FPC mounting portion 21c is to be performed after covering the liquid crystal panel 2 with the resin layer 3 due to circumstances of a manufacturing factory of the liquid crystal module 1, or the like.

### Modification Example 4 of First Embodiment

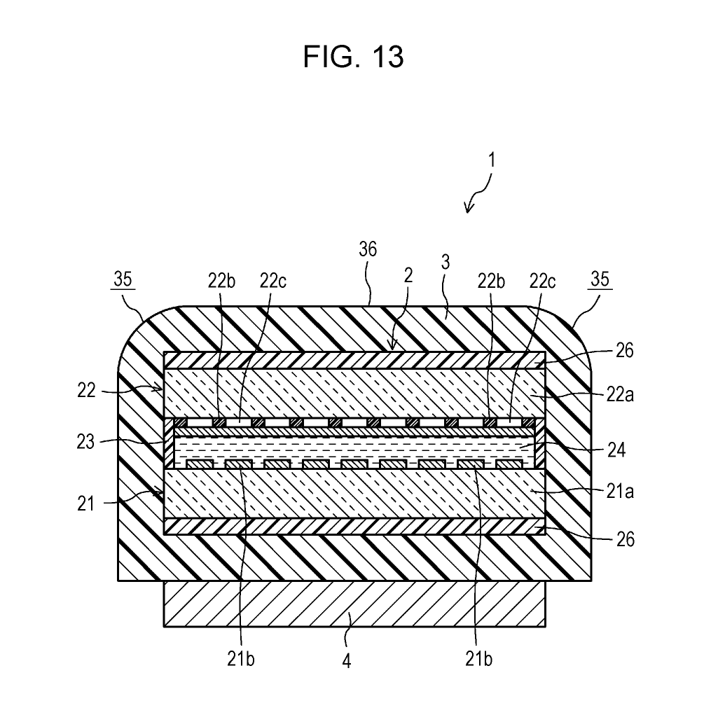

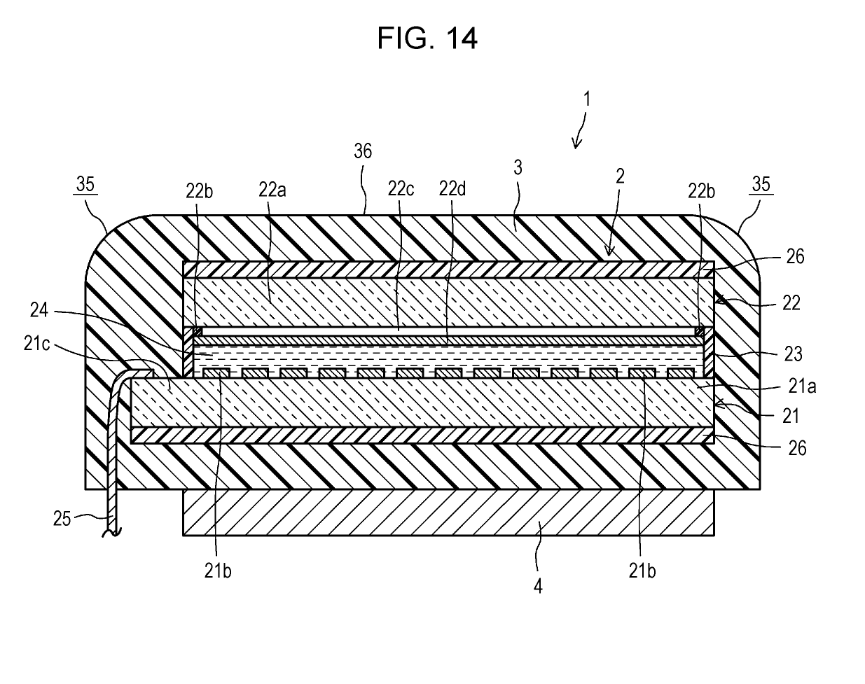

FIG. 13 is a diagram of a liquid crystal module 1 according to a modification example 4 in the first embodiment which corresponds to FIG. 3, and FIG. 14 is a diagram of the liquid crystal module 1 according to the modification example 4 which corresponds to FIG. 4. In the modification example 4, a configuration of a resin layer is different from that in the first embodiment. Therefore, the resin layer will be mainly described. In addition, in FIGS. 13 and 14, the same configurations as those in the first embodiment will be given the same reference numerals.

In the liquid crystal module 1 according to the modification example 4, a portion corresponding to the peripheral edge portion of the CF substrate 22 on the outer surface of the resin layer 3 is formed as a convexly curved surface 35, and a continuous portion 36 as the inner portion which is continuous to the convexly curved surface 35 is flatly formed.

According to the configuration, when a user views the convexly curved surface 35 from the CF substrate 22 side of the resin layer 3, the user is able to view light which is refracted into the inside of the peripheral edge portion (frame region) of the CF substrate 22 on the convexly curved surface 35, that is, into the display region side of the liquid crystal panel 2. On the other hand, when a user views the continuous portion 36, that is, a portion on the display region side from the CF substrate 22 side of the resin layer 3, the user is able to view light which comes directly from the display region side since the continuous portion 36 is flatly formed. Accordingly, when a user views the outer surface of the resin layer 3 from the CF substrate 22 side of the resin layer 3, the user is able to view only the display region without viewing the frame region. In addition, in the above described example, the peripheral edge portion of the resin layer 3 is formed as the convexly curved surface, however, as the other example, it is also possible to manufacture a liquid crystal module which is characteristic in design by making the of the resin layer 3 corresponding to a center portion of the display region as the convexly, or concavely curved surface, and by changing the thickness of the resin layer 3 in the display region.

### The Other Modification Example of First Embodiment

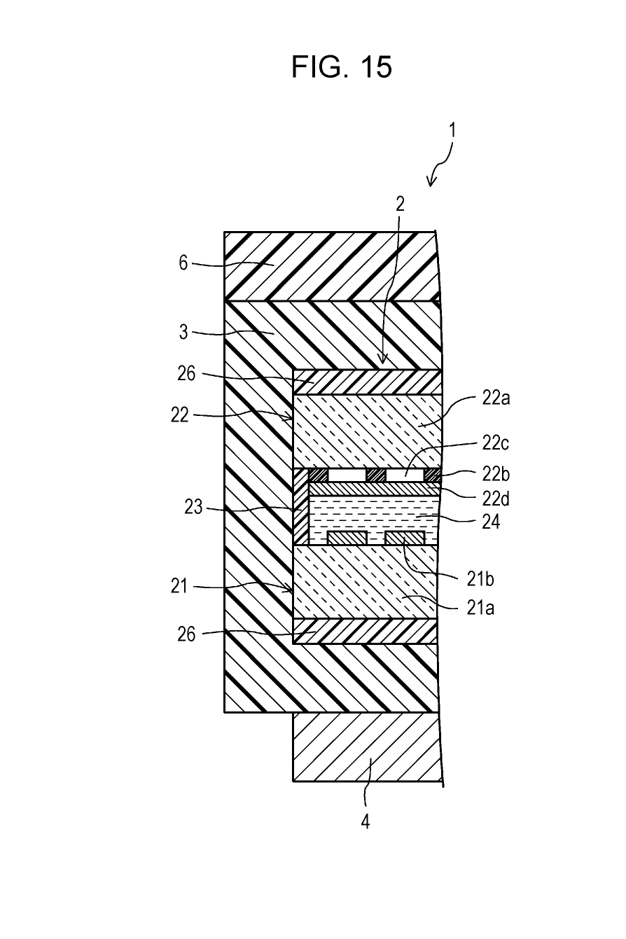

In the first embodiment, as illustrated in FIG. 15, a front plate 6 such as a touch panel, or a protecting plate, for example, may be attached to the outer surface of the resin layer 3 on the CF substrate 22 side. When attaching the front plate 6 to the outer side surface of the resin layer 3, well-known means (for example, adhesive, or adhesive tape) may be used.

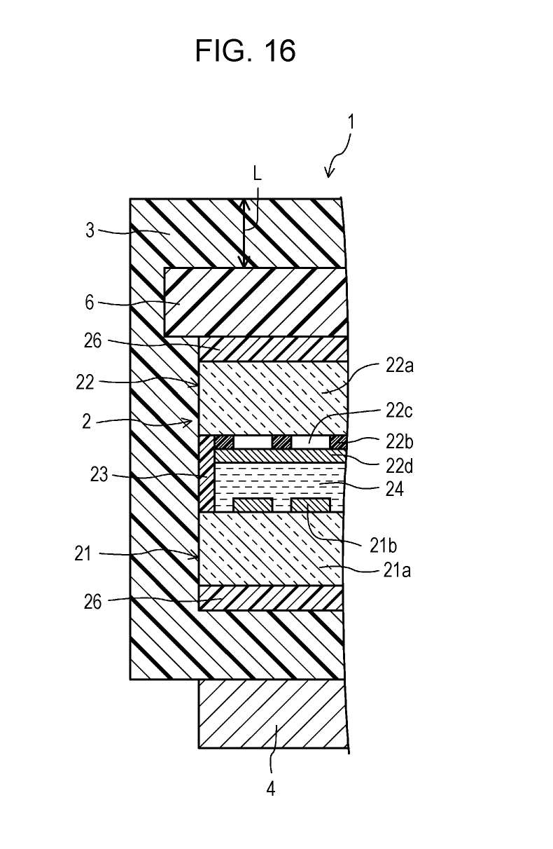

Here, as illustrated in FIG. 16, that is, it may be a configuration in which a laminated body is formed by attaching the front plate 6 to the CF substrate 22 side of the liquid crystal panel 2, and the laminated body is covered with the resin layer 3. In this configuration, since the front plate 6 is located inside the resin layer 3, when a touch panel of a capacitive type is adopted as the front plate 6, if a distance L between the front plate 6 and the outer surface of the resin layer 3, that is, the thickness of the resin layer 3 is large, the touch panel doesn't react, therefore, it is preferable that the distance L be set to 2 mm or less.

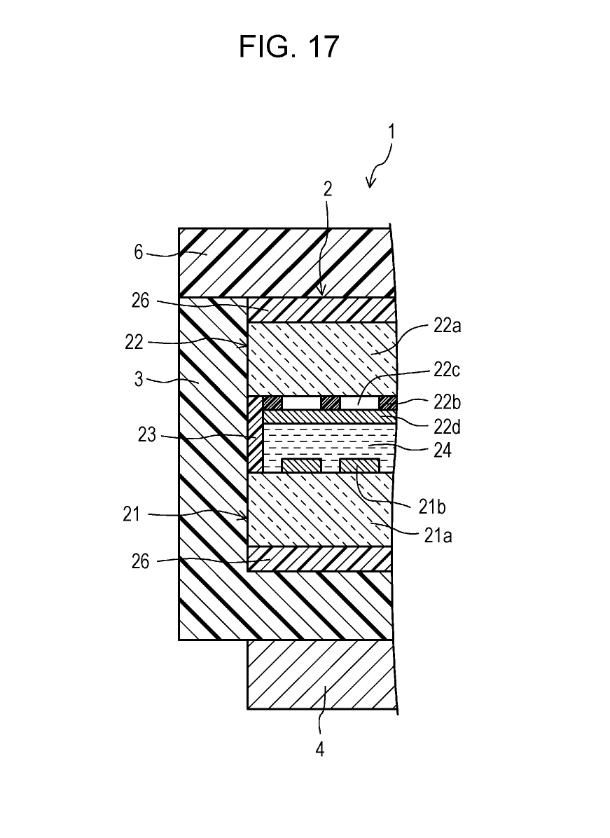

In addition, as illustrated in FIG. 17, the front plate 6 may be attached to the CF substrate 22 side of the liquid crystal panel 2 by not providing the resin layer 3 on the CF substrate 22 side of the liquid crystal panel 2.

### Second Embodiment

Subsequently, a liquid crystal module 101 according to a second embodiment will be described.

### Configuration of Liquid Crystal Module

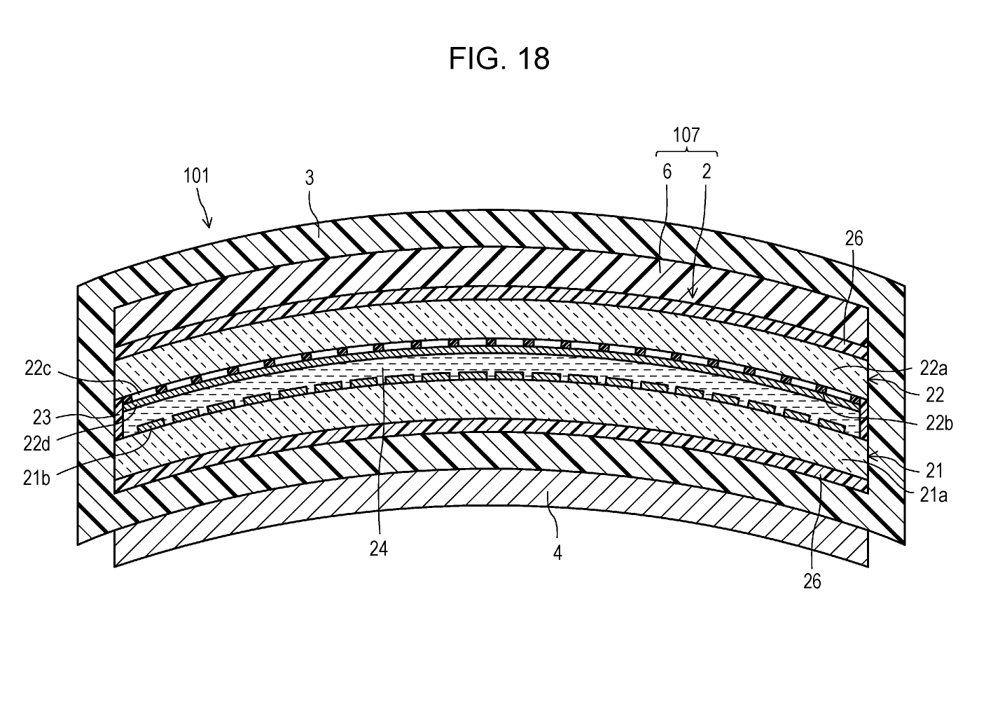

FIG. 18 is a diagram of the liquid crystal module 101 which corresponds to FIG. 3. In FIG. 18, the same configurations as those in the first embodiment will be given the same reference numerals. Hereinafter, descriptions of the same configurations as those in the first embodiment are appropriately omitted, and configurations which are different from those in the first embodiment will be mainly described.

The liquid crystal module 101 includes a laminated body 107 in which a liquid crystal panel 2 and a front plate 6 are bonded.

Similarly to the first embodiment, the liquid crystal panel 2 includes a TFT substrate 21, a CF substrate 22 which faces the TFT substrate 21, a sealing material 23 which bonds both peripheral edge portions of the TFT substrate 21 and the CF substrate 22 in the whole periphery, and a liquid crystal layer 24 which is enclosed inside the sealing material 23 between the TFT substrate 21 and the CF substrate 22.

In addition, the TFT substrate 21 and the CF substrate 22 are flexible since insulating substrates 21a and 22a are formed by, for example, a thin plate such as a rectangular flat-plate shaped plastic substrate of which the thickness is 0.3 mm or less, a rectangular flat-plate shaped glass substrate of which the thickness is 0.1 mm or less, or the like.

The front plate 6 is for example, a touch panel, or a protecting plate, and has a curved surface shape.

The laminated body 107 is a structure body having a curved surface shape, and has a structure in which the front plate 6 is attached to the CF substrate 22 side of the liquid crystal panel 2. The whole laminated body 107 is covered with the resin layer 3, and is integrally bonded to the resin layer 3.

The resin layer 3 has a curved surface shape corresponding to the laminated body 107, and the outer surface on the TFT substrate 21 side is attached with a backlight 4.

The liquid crystal module 101 is configured as described above.

### Manufacturing Method of Liquid Crystal Module

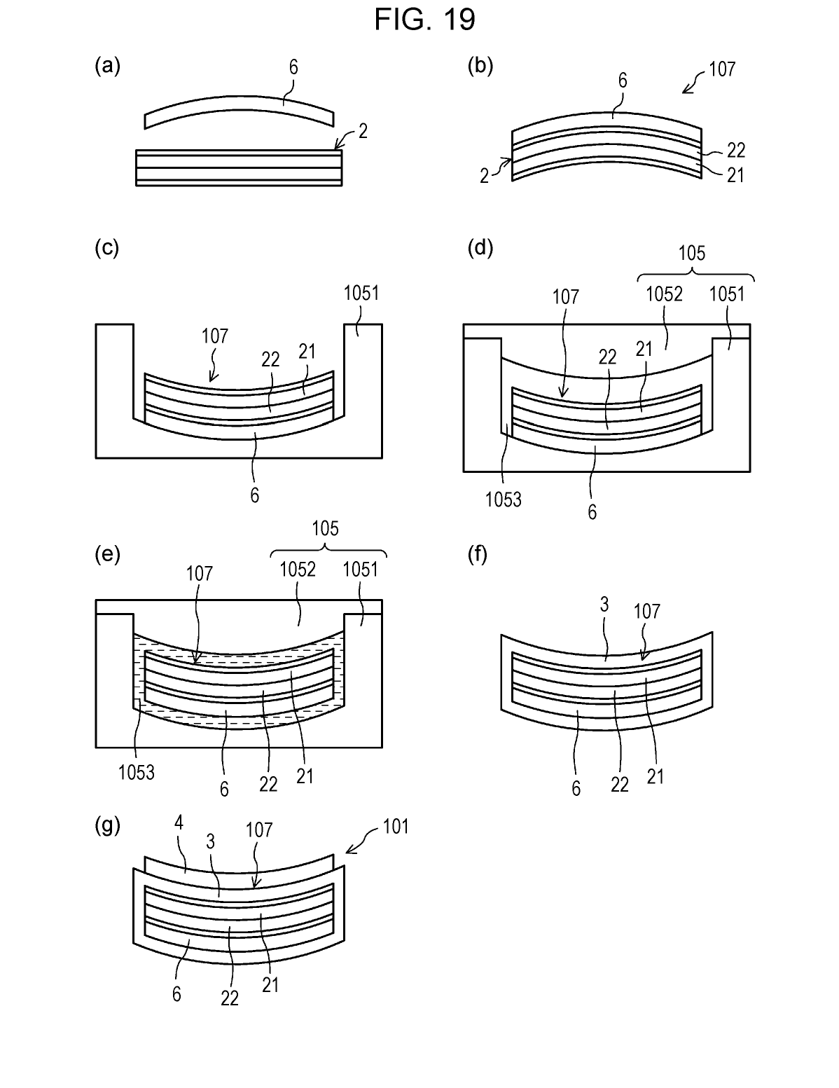

Subsequently, a manufacturing method of the liquid crystal module 101 will be described with reference to FIG. 19.

First, the liquid crystal panel 2 is manufactured based on the manufacturing process of the liquid crystal panel which is described in the first embodiment. In addition, as illustrated in FIG. 19(a), the front plate 6 and the liquid crystal panel 2 are prepared.

Subsequently, the liquid crystal panel 2 is set to have a curved surface shape by deforming the liquid crystal panel 2 to be bent, and the front plate 6 is attached to the CF substrate 22 side of the curved surface shaped liquid crystal panel 2 using, for example, an adhesive, an adhesive tape, or the like. In this manner, as illustrated in FIG. 19(b), the curved surface shaped laminated body 107 is obtained.

Subsequently, similarly to the first embodiment, insertion molding is performed in order to provide the resin layer 3 in the laminated body 107. The forming die 105 for performing the insertion molding is formed by the lower die 1051 and the upper die 1052, and the upper die 1052 is provided with an injection hole (not shown) for injecting a resin material of the resin layer 3. A method of providing the resin layer 3 in the laminated body 107 using the forming die 105 will be described in detail.

First, as illustrated in FIG. 19(c), the laminated body 107 is provided at the base of the lower die 1051 so that the TFT substrate 21 side becomes the upper side.

Subsequently, as illustrated in FIG. 19(d), the upper die 1052 is closed by placing the lower die 1051. In this manner, a curved surface shaped cavity 1053 is formed in the forming die 105, and the laminated body 107 is provided in the cavity 1053.

Subsequently, as illustrated in FIG. 19(e), the resin material of the resin layer 3 is injected to the cavity 1053 from the injection hole of the upper die 1052, and the resin material is filled in the cavity 1053. In this manner, the resin material wraps the laminated body 107 around, and the whole laminated body 107 is covered with the resin material.

In addition, when demolding the forming die 105 after the resin material is cooled down, and is cured, as illustrated in FIG. 19(f), it is possible to obtain the laminated body 107 of which the whole portion is covered with the resin layer 3, and which is integrally bonded to the resin layer 3.

Finally, as illustrated in FIG. 19(g), it is possible to manufacture the liquid crystal module 101 by attaching the backlight 4 on the outer surface of the resin layer 3 on the TFT substrate 21 side, and by cutting (finishing) an unnecessary portion corresponding to the insertion hole of the upper die 1052 in the resin layer 3.

### Effects of Second Embodiment

According to the second embodiment, since the laminated body 107 is configured in a state in which the liquid crystal panel 2 (TFT substrate 21 and CF substrate 22) is deformed to be bent, there is a concern that the front plate 6 and the liquid crystal panel 2 may be separated from each other due to a reaction force against the bending deformation. Therefore, since the front plate 6 and the liquid crystal panel 2 resist the above described reaction force by being pushed each other by the resin layer 3, by covering the laminated body 107 using the resin layer 3, it is possible to prevent the front plate 6 and the liquid crystal panel 2 from being separated.

In addition, since the resin layer 3 and the laminated body 107 are integrally bonded by covering the whole laminated body 107 with the resin layer 3, similarly to the first embodiment, the sealing material 23 is supported by the resin layer 3 from the outside. For this reason, even if the width of the sealing material 23 is narrow, it is possible to prevent the sealing material 23 from separating from the TFT substrate 21 and the CF substrate 22.

### Third Embodiment

Subsequently, a third embodiment will be described. The third embodiment is an embodiment of an electronic apparatus to which the liquid crystal module according to present invention is applied.

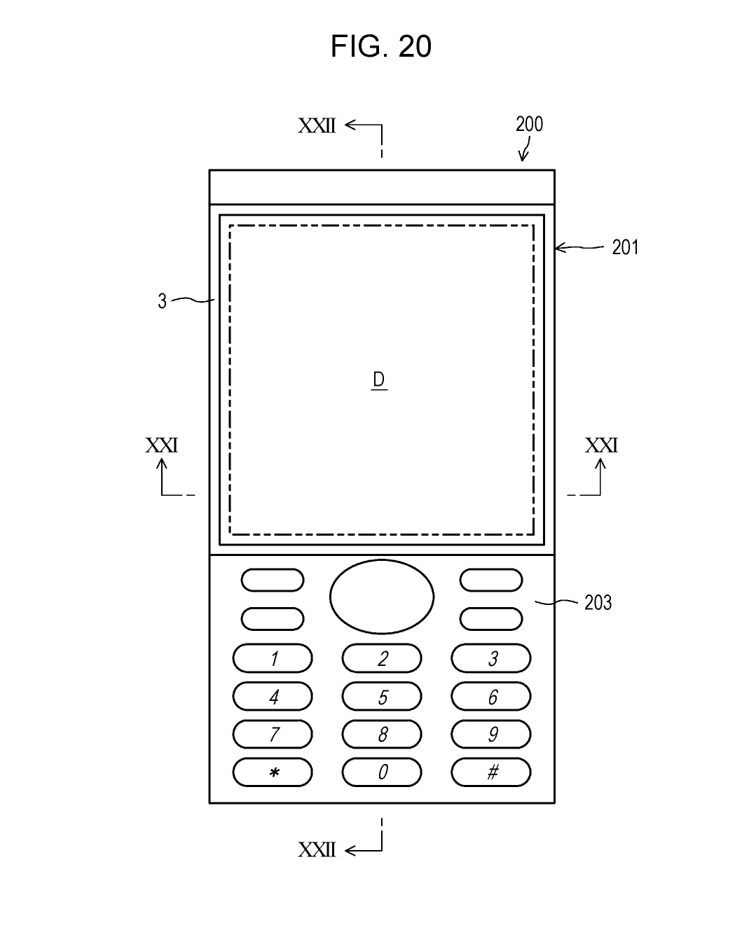

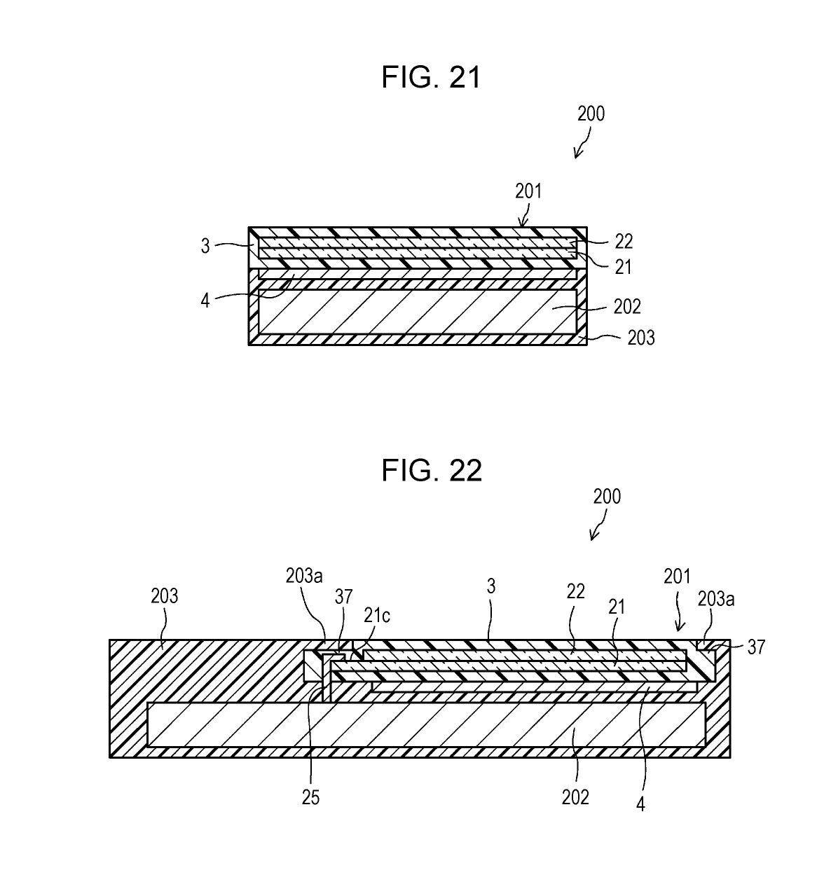

FIG. 20 is a schematic front view of a mobile phone 200 in which the liquid crystal module according to the present invention is used as a display. FIG. 21 is a cross-sectional view which is taken along line XXI-XXI of the mobile phone 200, and FIG. 22 is a cross-sectional view which is taken along line XXII-XXII of the mobile phone 200. In addition, in FIGS. 20 to 22, the same configurations as those in the first embodiment will be given the same reference numerals.

The mobile phone 200 includes a liquid crystal module 201 for image displaying, a circuit unit 202 which is provided on the rear surface side (that is, lower side in FIGS. 21 and 22) of the liquid crystal module 201, and an approximately rectangular flat-plate shaped housing 203 which accommodates the liquid crystal module 201 and the circuit unit 202.

In the liquid crystal module 201, only a configuration of a resin layer 3 is different from that in the liquid crystal module 1 according to the first embodiment. For this reason, detailed descriptions will be referred to in the first embodiment, and only the configuration of the resin layer will be described. Notches 37 which are engaged with claws 203a of the housing 203 which will be described later are respectively provided at both longitudinal end portions (that is, end portions on left and right in FIG. 22) of the resin layer 3. This point is different from the liquid crystal module 1 according to the first embodiment. When providing the notches 37 and 37 in the resin layer 3, the shape of the forming die when performing the insertion molding may be changed.

Among side surfaces of the liquid crystal module 201, that is, the outer side surface s of the resin layer 3, longitudinal both side portions of the liquid crystal module 201 (that is, vertical direction in FIG. 20) are covered with the housing 203, and on the other hand, lateral both side portions of the liquid crystal module 201 (that is, horizontal direction in FIG. 20) are not covered with the housing 203, and are exposed to the outside. In addition, the outer side surface of the resin layer 3 on the lateral both sides are flush with the end surface of the housing 203 by aligning in the longitudinal direction and the width direction of the mobile phone 200.

The circuit unit 202 is configured by a circuit board which supplies a necessary control signal to a driver LSI of the liquid crystal module 201, a battery, and the like, and an FPC 25 of the liquid crystal module 201 is connected to the circuit board of the circuit unit 202.

A portion at which the liquid crystal module 201 of the housing 203 is accommodated is provided with the claws 203a at respective both side portions in the longitudinal direction, and when the claws 203a and 203a are engaged with the notches 37 and 37 of the liquid crystal module 201, the liquid crystal module 201 is prevented from separating from the housing 203. In addition, the claw 203a on one longitudinal side (left side in FIG. 22) is provided at the front surface side of an FPC mounting portion 21c of the liquid crystal module 201, and due to this, a user is not able to view the FPC mounting portion 21c which is a frame region of the liquid crystal module 201.

### Effects of Third Embodiment

According to the third embodiment, since the mobile phone 200 includes the same liquid crystal module 201 as that in the first embodiment, it is possible to prevent the liquid crystal panel 2 from being defective when the sealing material 23 is separated from the TFT substrate 21, or the CF substrate 22, even when the width of the sealing material 23 is narrow, in a case in which the mobile phone is used in a reliability test which is performed in circumstances of a high temperature or a high temperature and high humidity, or when the mobile phone is used in a region of a high temperature and high humidity, or the like.

In addition, since the outer side surfaces of the resin layer 3 on the lateral both sides of the liquid crystal module 201 are not covered with the housing 203, and are aligned with the end surface of the housing 203 in the longitudinal direction of the mobile phone 200, a total (approximately 1.5 mm) of the width (approximately 0.5 mm) of the frame region of the liquid crystal panel 2 and the thickness (approximately 1 mm) of the resin layer 3 becomes a non-display region, and it is possible to realize an electronic apparatus of which a display region D is extremely large. In addition, since the liquid crystal panel 2 is covered with the resin layer 3, enough strength is secured, even when the outer side surfaces of the resin layer 3 on the lateral both end sides of the liquid crystal module 201 are not covered with the housing 203, and are exposed to the outside.

### The Other Embodiment

The present invention may have the following configuration with respect to the first to third embodiments.

That is, the active matrix driving type liquid crystal module is adopted in the first to third embodiments, however, it is not limited to this, and it may be a simple matrix driving type liquid crystal module.

### INDUSTRIAL APPLICABILITY

In the liquid crystal module according to the present invention, since it is possible to prevent the sealing material from separating from the substrate even when the width of the sealing material is narrow, it is effective in a point that it is possible to prevent the liquid crystal panel from being deteriorated due to air bubbles which are generated in the liquid crystal layer because of air which is infiltrated in the liquid crystal layer from the outside of the sealing material.

### REFERENCE NUMERALS

1, 101, 201: LIQUID CRYSTAL MODULE
2: LIQUID CRYSTAL PANEL
21: TFT SUBSTRATE (ELEMENT SUBSTRATE)
21c: FLEXIBLE PRINTED CIRCUIT MOUNTING PORTION
22: CF SUBSTRATE (OPPOSING SUBSTRATE)
23: SEALING MATERIAL
24: LIQUID CRYSTAL LAYER
26: OPTICAL FILM
3: RESIN LAYER
31: OUTER SIDE SURFACE
32: INNER SIDE SURFACE
33: TFT SUBSTRATE PERIPHERAL EDGE CORRESPONDING PORTION
34: CF SUBSTRATE PERIPHERAL EDGE CORRESPONDING PORTION
35: CONVEXLY CURVED SURFACE
4: BACKLIGHT
6: FRONT PLATE
107: LAMINATED BODY
200: MOBILE PHONE (ELECTRONIC APPARATUS)

1. A liquid crystal module comprising:
a liquid crystal panel which includes an element substrate; an opposing substrate which faces the element substrate; a frame-shaped sealing material which bonds peripheral edge portions of both the element substrate and opposing substrate in a whole periphery; and a liquid crystal layer which is enclosed in an inner side of the sealing material between the element substrate and the opposing substrate,
wherein at least an outer side of the sealing material of the liquid crystal panel is provided with a resin layer so as to cover the sealing material, and the resin layer and the sealing material are integrally bonded.

2. The liquid crystal module according to claim 1,
wherein the resin layer is formed of a transparent resin, and covers the whole liquid crystal panel.

3. The liquid crystal module according to claim 1,
wherein a flexible printed circuit board mounting portion is provided at the outer side of the sealing material of the element substrate, and
wherein the resin layer is formed of a transparent resin, and covers portions excepting for the flexible printed circuit board mounting portion of the liquid crystal panel.

4. The liquid crystal module according to claim 2,
wherein a portion corresponding to a peripheral edge portion of the opposing substrate on an outer surface of the resin layer is formed as a convexly curved surface, and an inner side portion which is continuous to the convexly curved portion is flatly formed.

5. The liquid crystal module according to claim 2, further comprising:
a front plate which is attached to the outer surface of the opposing substrate, and configures a laminated body along with the liquid crystal panel,
wherein at least one of the front plate and the liquid crystal panel is flexible,
wherein at least one of the front plate and the liquid crystal panel which configure the laminated body is formed as a curved surface shape using bending deformation, and
wherein the resin layer covers the laminated body.

6. The liquid crystal module according to claim 2, further comprising:
a backlight which is attached to an outer surface of the resin layer on an element substrate side, and illuminates the liquid crystal panel from the element substrate side.

7. The liquid crystal module according to claim 6,
wherein an optical film is attached to each of the element substrate side on the resin layer and the outer surface on the opposing substrate side.

8. The liquid crystal module according to claim 2,
wherein the resin layer further includes the backlight which is formed in a flat-plate shape, is attached to the outer surface of the resin layer on the element substrate side, and illuminates the liquid crystal panel from the element substrate side, and
wherein at least one of an outer side surface and an inner side surface of the resin layer is set to have lower reflectivity than that of other surfaces of the resin layer.

9. The liquid crystal module according to claim 2,
wherein the resin layer further includes the backlight which is formed in the flat-plate shape, is attached to the outer surface of the resin layer on the element substrate side, and illuminates the liquid crystal panel from the element substrate side, and
wherein at least one of a portion corresponding to a peripheral edge portion of the element substrate on the outer surface of the resin layer, and a portion corresponding to a peripheral edge portion of the opposing substrate is set to have lower transmittance of light than that in other portions of the resin layer.

10. The liquid crystal module according to claim 2,
wherein the resin layer further includes the backlight which is formed in the flat-plate shape, is attached to the outer surface of the resin layer on the element substrate side, and illuminates the liquid crystal panel from the element substrate side, and
wherein the outer side surface of the resin layer is formed as a light scattering surface.

11. An electronic apparatus comprising:
the liquid crystal module according to claim 1.
